(19) United States
(12) Patent Application Publication
(10) Pub. No.: US 2025/0030191 A1
(43) Pub. Date: Jan. 23, 2025

(54) Cluster Block Housing For Electrical Leads

(71) Applicant: Tyco Electronics (Shanghai) Co., Ltd., Shanghai (CN)

(72) Inventors: Zhimin Zhang, Shanghai (CN); Wenfang (Felix) Zhang, Shanghai (CN); Tongbao (Tim) Ding, Shanghai (CN); Yongjian (Justin) Huang, Shanghai (CN); Chunjie Hu, Shanghai (CN); Jinyu Zhang, Shanghai (CN)

(73) Assignee: Tyco Electronics (Shanghai) Co., Ltd., Shanghai (CN)

(21) Appl. No.: 18/776,747

(22) Filed: Jul. 18, 2024

(30) Foreign Application Priority Data
Jul. 18, 2023 (CN) 202310884647.4

(51) Int. Cl. H01R 13/514

(52) U.S. Cl. CPC H01R 13/514

(57) ABSTRACT

A cluster block housing for electrical leads includes a plurality of connected casings that are separable and identically shaped. Each casing of the plurality of casings includes a plug-receiving aperture. Adjacently connected two casings of the plurality of casings are adapted to be positioned adjacently at a plurality of positions relative to each other. Each of plurality of positions corresponds to a distinct distance between the plug-receiving apertures of the two adjacent casings. The plug-receiving apertures are maintained in a row in each of the plurality of positions.

### CROSS-REFERENCE TO RELATED APPLICATION

This application claims the benefit of Chinese Patent Application No. 202310884647.4 filed on Jul. 18, 2023, in the State Intellectual Property Office of China, the whole disclosure of which is incorporated herein by reference.

### FIELD OF THE INVENTION

Embodiments of the present disclosure relate to a lead structure, and more particularly, to a cluster block housing for electrical leads.

### BACKGROUND

Equipment such as a refrigerator, an air conditioner, an automobile, a vending machine, etc. requires the application of a compressor system. Traditionally, wiring terminals used for a compressor of such an equipment are round and terminal housings having plug holes arranged in triangular shape are used accordingly. With technological developments, straight-line wiring terminals begin to appear in applications. For example, they are applied in emerging markets such as electric vehicles (e.g., battery electric vehicles or hybrid electric vehicles) and the like. Such wiring terminals need to be connected to terminal housings. There are two types of terminal housings in the prior art that are adapted for such wiring terminals, one is straight-line type and the other is the stepped type.

However, the distance between plug-receiving apertures of these existing terminal housings for round or straight-line type wiring terminals is fixed. The distance between pins of wiring terminals for different equipment may be different. As a result, it is necessary to remake a mold to manufacture terminal housings adapted for different wiring terminals, which increases cost.

### SUMMARY

According to an embodiment of the present disclosure, a cluster block housing for electrical leads includes a plurality of connected casings that are separable and identically shaped. Each casing of the plurality of casings includes a plug-receiving aperture. Adjacently connected two casings of the plurality of casings are adapted to be positioned adjacently at a plurality of positions relative to each other. Each of plurality of positions corresponds to a distinct distance between the plug-receiving apertures of the two adjacent casings. The plug-receiving apertures are maintained in a row in each of the plurality of positions.

### BRIEF DESCRIPTION OF THE DRAWINGS

The invention will now be described by way of example with reference to the accompanying Figures, of which:

FIG. 1A illustrates an example cluster block housing for electrical leads according to a first embodiment of the disclosure.

FIG. 1B illustrates a single casing of the cluster block housing of FIG. 1A as viewed from one angle.

FIG. 1C illustrates the single casing of the cluster block housing of FIG. 1A as viewed from another angle.

FIG. 1D illustrates the single casing of the cluster block housing of FIG. 1A as viewed from yet another angle.

FIG. 2A illustrates an example cluster block housing for electrical leads according to a second embodiment of the disclosure.

FIG. 2B illustrates a single casing of the cluster block housing of FIG. 2A as viewed from one angle.

FIG. 2C illustrates the single casing of the cluster block housing of FIG. 2A as viewed from another angle.

FIG. 2D illustrates the single casing of the cluster block housing of FIG. 2A as viewed from yet another angle.

FIG. 3A illustrates an example cluster block housing for electrical leads according to a third embodiment of the disclosure.

FIG. 3B illustrates a single casing of the cluster block housing of FIG. 3A as viewed from one angle.

FIG. 3C illustrates the single casing of the cluster block housing of FIG. 3A as viewed from another angle.

FIG. 3D illustrates the single casing of the cluster block housing of FIG. 3A as viewed from yet another angle.

FIG. 4A illustrates a cross-sectional view of a first connection portion of the single casing of FIG. 3B.

FIG. 4B illustrates a cross-sectional view of a first connection portion of a single casing according to another embodiment of the disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As mentioned above, as the distance between the plug-receiving apertures of existing terminal housings is fixed, the terminal housing cannot be directly applied to terminals with different pin spacings. Accordingly, it is necessary to design terminal housings for different terminals, which increases manufacturing cost.

In view of the above defects of the existing terminal housing, the present disclosure provides a cluster block housing for electrical leads with a different structure. In at least some embodiments, the present disclosure includes a cluster block housing that supports different plug-receiving aperture spacings by providing a plurality of casings that are separable and offset at various distances relative to each other. In this application, the distance (or spacing) between plug-receiving apertures refers to the distance between centers of plug-receiving apertures of respective adjacent housings.

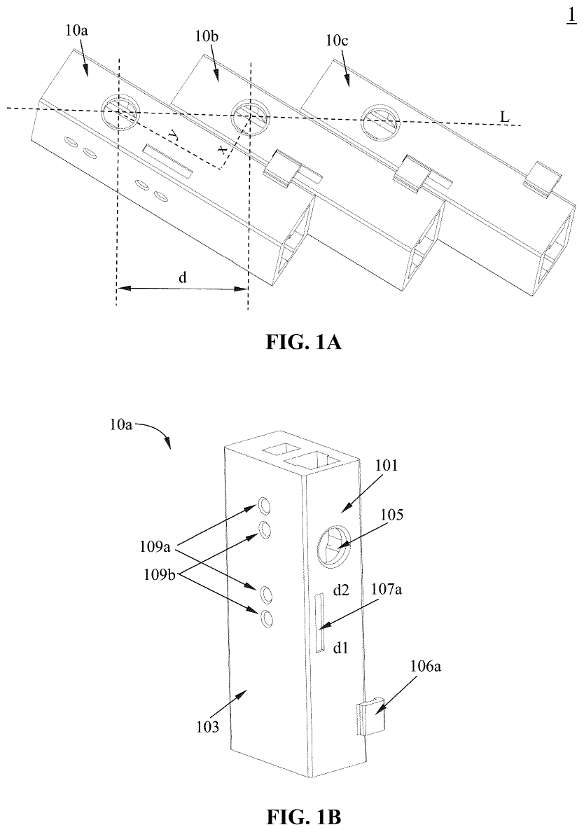

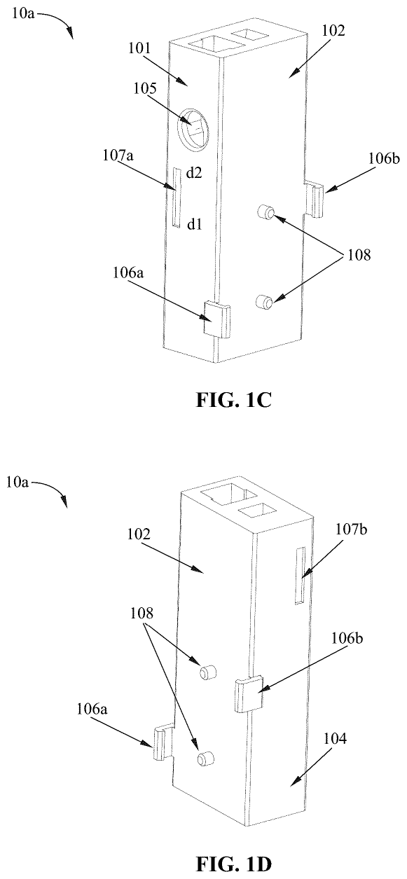

With reference to FIG. 1A, an example cluster block housing 1 for electrical leads according to a first embodiment of the disclosure is illustrated. As shown in FIG. 1A, the cluster block housing 1 includes a plurality of casings 10a, 10b and 10c that have the same shape and are separable or detachable (three casings are shown in the figure, which is only for illustration and is not intended to limit the scope of protection of the present disclosure). FIGS. 1B-1D illustrate a single casing 10a of the cluster block housing 1 of FIG. 1A as viewed from different angles.

As shown in FIGS. 1A-ID, each casing of the plurality of casings 10a, 10b and 10c includes a plug-receiving aperture 105, wherein every adjacently connected two casings (e.g., a first casing 10a and a second casing 10b) can be positioned adjacently at a plurality of positions relative to each other, to change the distance between the plug-receiving apertures of the two casings, and can keep the plug-receiving apertures 105 of the plurality of casings in a row or adjacently staggered.

As shown in FIG. 1A, when the plurality of casings 10a, 10b and 10c are connected together one after another, the plug-receiving apertures 105 of each casing can be kept in one row, i.e., located on a straight line L, to be adapted for straight-line wiring terminals. The distance d between the plug-receiving apertures 105 of two adjacent casings can be calculated by the lateral distance x and longitudinal distance y between the plug-receiving apertures 105 of the two casings, e.g., d=\sqrt{x²+y²}. The lateral distance x between the plug-receiving apertures 105 of the two casings generally remains constant and the longitudinal distance y is variable. In other examples, the plug-receiving apertures 105 of the plurality of casings 10a, 10b and 10c can be kept adjacently staggered. For example, the plug-receiving apertures 105 of the first casing 10a and the second casing 10b are longitudinally offset by a distance y1, the plug-receiving apertures 105 of the second casing 10b and the third casing 10c are longitudinally offset by a distance y2, and the plug-receiving apertures 105 of the first casing 10a and the third casing 10c are longitudinally offset by a distance y3, so that the plug-receiving apertures 105 of the plurality of casings 10a, 10b and 10c are not kept in a straight line (e.g., y1≠y2, or y1=y2 and y3=0, etc.), such as being arranged in a triangle or delta shape (not shown), to be adapted for round type wiring terminals. Since the two casings can be positioned adjacently relative to each other at multiple positions (i.e., offset by different distances), the distance d can be varied to accommodate wiring terminals with different pin spacings. For example, a first position may correspond to a plug-receiving aperture spacing d1, a second position may correspond to a plug-receiving aperture spacing d2, and so on. Without loss of generality, two adjacently connected casings are illustrated below by taking the casings 10a and 10b as examples.

Still referring generally to FIGS. 1A-1D, each casing includes a first connection portion 106a and a second connection portion 107a. The first connection portion 106a of a first casing 10a of the two casings 10a, 10b can cooperate with the second connection portion 107a of a second casing 10b, so that the first casing 10a can, relative to the second casing 10b, be adjacently positioned against the second casing 10b at the plurality of positions.

Each casing includes a top surface or a first surface 101, two opposite side surfaces 102, 103 or a second surface 102 and a third surface 103. The second surface 102 and the third surface 103 are disposed at an angle (e.g., perpendicular, or not perpendicular) relative to the first surface 101. The plug-receiving aperture 105 is disposed at the first surface 101. For example, the second surface 102 may be parallel to the third surface 103. The first connection portion 106a of the first casing 10a can cooperate with the second connection portion 107a of the second casing 10b, so that the second surface 102 of the first casing 10a abuts against the third surface 103 of the second casing 10b.

In this embodiment, the first connection portion 106a of the first casing 10a can perform snap fit with the second connection portion 107a of the second casing 10b, so that the second surface 102 of the first casing 10a abuts against the third surface 103 of the second casing 10b. In particular, the first connection portion 106a and the second connection portion 107a of each casing are disposed at the first surface 101 of each casing. The first connection portion 106a includes a snap member and the second connection portion 107a includes a snap groove. The snap member of the first casing 10a can be positioned at different locations in the snap groove of the second casing 10b. In this way, the second surface 102 of the first casing 10a abuts against the third surface 103 of the second casing 10b at a respective position of the plurality of positions to thereby securely connect the two casings 10a, 10b together.

In order to accurately abut or join the first casing 10a against the second casing 10b at a respective position of the plurality of positions, each casing may further include positioning member(s) 108 disposed at the second surface 102 (see FIGS. 1C and 1D). A plurality of sets of positioning holes 109a, 109b (FIG. 1B) are disposed at the third surface 103, wherein the size of each positioning hole may be adapted to accommodate the positioning member 108. When the positioning member(s) 108 of the first casing 10a is positioned in a respective set of positioning holes of the plurality sets of positioning holes 109a, 109b of the second casing 10b, the second surface 102 of the first casing 10a abuts against the third surface 103 of the second casing 10b at a respective position of the plurality of positions. This prevents the movement of the snap member 106a of the first casing 10a in the snap groove 107a of the second casing 10b (e.g., upward, and downward movement in the direction of the length of the snap groove).

For example, in the case that the positioning member(s) 108 of the first casing 10a are positioned in the first set of positioning holes 109b of the second casing 10b, the spacing distance d between the plug-receiving apertures is a first spacing distance d1. In the case that the positioning member(s) 108 of the first casing 10a are positioned in the second set of positioning holes 109a of the second casing 10b, the spacing distance d between the plug-receiving apertures is a second spacing distance d2, where d1<d2. It should be understood that the number of positioning member(s) 108 may be one or more (two positioning members are shown in the figure, which is only for illustration and is not intended to limit the scope of protection of the present disclosure). Compared with one positioning member 108, multiple positioning members 108 can provide better positioning effect. In addition, the set number of the plurality sets of positioning holes may be two or more (two sets are shown in the figure, which is only for illustration and is not intended to limit the scope of protection of the present disclosure) to achieve adjustment of two or more spacing distances between the plug-receiving apertures.

For example, each casing may further include a bottom surface or a fourth surface 104 opposite to the first surface 101, and a third connection portion 106b and a fourth connection portion 107b may be provided at the fourth surface 104. Similar to the first connection portion 106a and the second connection portion 107a, the third connection portion 106b of the first casing 10a can similarly cooperate with the fourth connection portion 107b of the second casing 10b, so that the second surface 102 of the first casing 10a abuts against the third surface 103 of the second casing 10b, which will not be described in detail here. By connecting the two casings from the first surface and the fourth surface, the two casings can be more securely connected together.

In the embodiment of FIGS. 1A-1D, each casing may further include position indication labels associated with the distance between the plug-receiving apertures to indicate multiple positions. For example, the position indication labels may be disposed at the first surface 101. As shown in FIGS. 1B and 1C, the position indication labels (such as characters d1, d2 as indicated in the figures, or characters, symbols or combinations thereof, etc.) may be disposed at the first surface 101 adjacent to the second connection portion 107a, to facilitate an user to be able to know the distance in a current setting of the plug-receiving apertures according to the position indication labels when the first connection portion 106a of the first casing 10a is positioned in the second connection portion 107a of the second casing 10b.

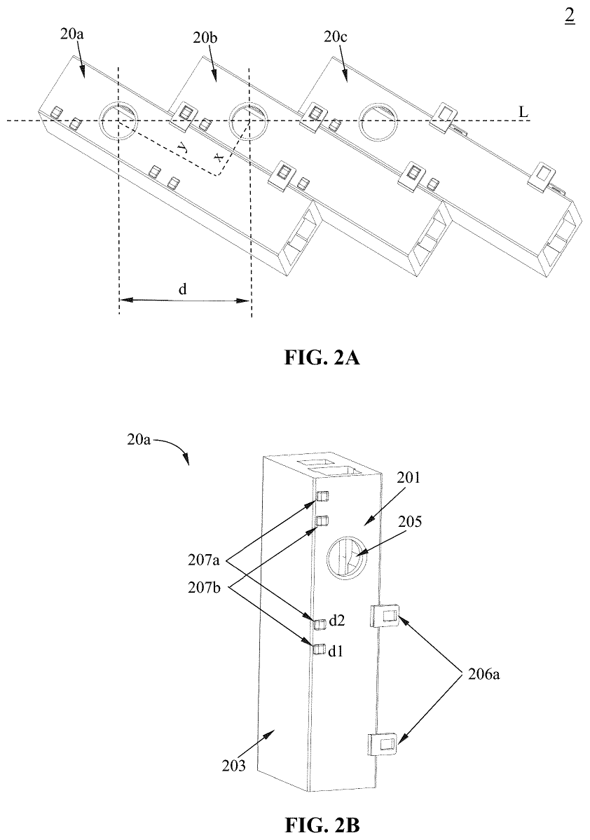

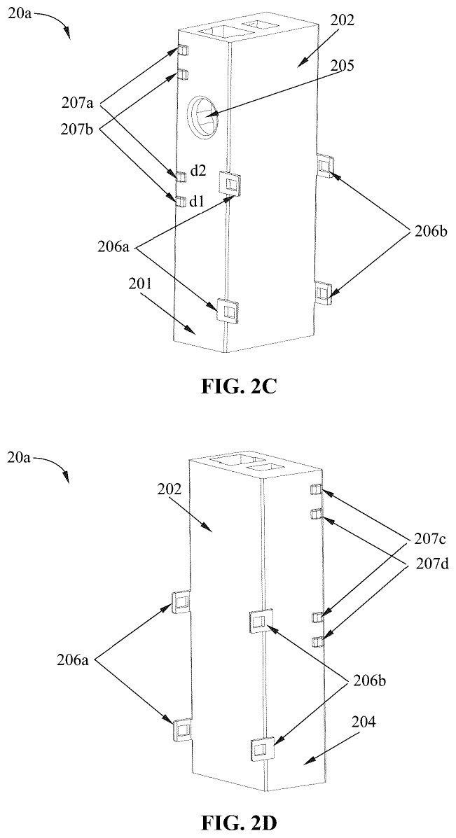

With reference to FIG. 2A, an example cluster block housing 2 for electrical leads according to a second embodiment of the disclosure is illustrated. As shown in FIG. 2A, the cluster block housing 2 includes a plurality of casings 20a, 20b and 20c that have the same shape and are separable or detachable (three casings are shown in the figure, which is only for illustration and is not intended to limit the scope of protection of the present disclosure). FIGS. 2B-2D illustrate a single casing 20a of the cluster block housing 2 of FIG. 2A as viewed from different angles.

As shown in FIGS. 2A-2D, each casing of the plurality of casings 20a, 20b and 20c includes a plug-receiving aperture 205, wherein every adjacently connected two casings (e.g., a first casing 20a and a second casing 20b) can be positioned adjacently at a plurality of positions relative to each other, to change the distance between the plug-receiving apertures of the two casings, and can keep the plug-receiving apertures 205 of the plurality of casings in a row or adjacently staggered.

As shown in FIG. 2A, when the plurality of casings 20a, 20b and 20c are connected together one after another, the plug-receiving apertures 205 of each casing can be kept in one row, i.e., located on a straight line L, to be adapted for straight-line wiring terminals. The distance d between the plug-receiving apertures 205 of two adjacent casings can be calculated by the lateral distance x and longitudinal distance y between the plug-receiving apertures 205 of the two casings, e.g., d=\sqrt{x²+y²}. The lateral distance x between the plug-receiving apertures 205 of the two casings generally remains constant and the longitudinal distance y is variable. In other examples, the plug-receiving apertures 205 of the plurality of casings 20a, 20b and 20c can be kept adjacently staggered. For example, the plug-receiving apertures 205 of the first casing 20a and the second casing 20b are longitudinally offset by a distance y1, the plug-receiving apertures 205 of the second casing 20b and the third casing 20c are longitudinally offset by a distance y2, and the plug-receiving apertures 205 of the first casing 20a and the third casing 20c are longitudinally offset by a distance y3, so that the plug-receiving apertures 205 of the plurality of casings 20a, 20b and 20c are not kept in a straight line (e.g., y1≠y2, or y1=y2 and y3=0, etc.), such as being arranged in a triangle or delta shape (not shown), to be adapted for round type wiring terminals. Since the two casings can be positioned adjacently relative to each other at multiple positions (i.e., offset by different distances), the distance d can be varied to accommodate wiring terminals with different pin spacings. For example, a first position may correspond to a plug-receiving aperture spacing d1, a second position may correspond to a plug-receiving aperture spacing d2, and so on. Without loss of generality, two adjacently connected casings are illustrated below by taking the casings 20a and 20b as examples.

As shown in FIGS. 2A-2D, each casing includes a first connection portion 206a and second connection portions 207a, 207b. The first connection portion 206a of a first casing 20a of the two casings 20a, 20b can cooperate with the second connection portions 207a, 207b of a second casing 20b, so that the first casing 20a can, relative to the second casing 20b, be adjacently positioned against the second casing 20b at the plurality of positions. For example, the second connection portions 207a, 207b include a plurality of sets of connection members, and the first connection portion 206a of the first casing 20a can cooperate with a respective set of connection members of the plurality of sets of connection members of the second casing 20b, so that the first casing 20a can, relative to the second casing 20b, be adjacently positioned against the second casing 20b at a respective position of the plurality of positions.

Each casing includes a top surface or a first surface 201, two opposite side surfaces 202, 203 or a second surface 202 and a third surface 203, wherein the second surface 202 and the third surface 203 are disposed at an angle (e.g., perpendicular, or not perpendicular) relative to the first surface 201. The plug-receiving aperture 205 is disposed at the first surface 201. For example, the second surface 202 may be parallel to the third surface 203. The first connection portion 206a of the first casing 20a can cooperate with the second connection portions 207a, 207b of the second casing 20b, so that the second surface 202 of the first casing 20a abuts against the third surface 203 of the second casing 20b.

In this embodiment, the first connection portion 206a of the first casing 20a can perform buckle fit with the second connection portions 207a, 207b of the second casing 20b, so that the second surface 202 of the first casing 20a abuts against the third surface 203 of the second casing 20b. In particular, the first connection portion 206a and the second connection portions 207a, 207b of each casing are disposed at the first surface 201 of each casing, and the first connection portion 206a includes buckle members having openings and the second connection portion 207a, 207b include a plurality of sets of protrusions. A respective set of protrusions of the plurality of sets of protrusions of the second casing 20b may be adapted to be positioned in the openings of the buckle members of the first casing 20a, so that the second surface 202 of the first casing 20a abuts against the third surface 203 of the second casing 20b at a respective position of the plurality of positions to thereby securely connect the two casings 20a, 20b together. For example, in the case that a first set of protrusions 207b of the plurality of sets of protrusions 207a, 207b of the second casing 20b is positioned in the openings of the buckle members of the first casing 20a, the spacing distance d between the plug-receiving apertures is a first spacing distance d1, while in the case that a second set of protrusions 207a of the plurality of sets of protrusions 207a, 207b of the second casing 20b is positioned in the openings of the buckle members of the first casing 20a, the spacing distance d between the plug-receiving apertures is a second spacing distance d2, where d1<d2. It should be understood that the number of buckle members 206a may be one or more (two buckle members are shown in the figure, which is only for illustration and is not intended to limit the scope of protection of the present disclosure). Compared with one buckle member, multiple buckle members can provide better securing effect. In addition, the set number of the plurality sets of protrusions may be two or more (two sets are shown in the figure, which is only for illustration and is not intended to limit the scope of protection of the present disclosure) to achieve adjustment of two or more spacing distances between the plug-receiving apertures.

For example, each casing may further include a bottom surface or a fourth surface 204 opposite to the first surface 201, and a third connection portion 206b and fourth connection portions 207c, 207d may be provided at the fourth surface 204. Similar to the first connection portion 206a and the second connection portions 207a, 207b, the third connection portion 206b of the first casing 20a can similarly cooperate with the fourth connection portions 207c, 207d of the second casing 20b, so that the second surface 202 of the first casing 20a abuts against the third surface 203 of the second casing 20b, which will not be described in detail here. By connecting the two casings from the first surface and the fourth surface, the two casings can be more securely connected together.

It should be understood that in other embodiments different from the first embodiment and the second embodiment, the cooperation of the first connection portion of the first casing and the second connection portion(s) of the second casing may be different from the cooperation of the third connection portion of the first casing and the fourth connection portion(s) of the second casing. For example, the cooperation of the first connection portion of the first casing and the second connection portion(s) of the second casing may be snap fit and the cooperation of the third connection portion of the first casing and the fourth connection portion(s) of the second casing may be buckle fit, or the cooperation of the first connection portion of the first casing and the second connection portion(s) of the second casing may be buckle fit and the cooperation of the third connection portion of the first casing and the fourth connection portion(s) of the second casing may be snap fit.

In the embodiment of FIGS. 2A-2D, each casing may further include position indication labels associated with the distance between the plug-receiving apertures to indicate multiple positions. For example, the position indication labels may be disposed at the first surface 201. As shown in FIGS. 2B and 2C, the position indication labels (such as characters d1, d2 as indicated in the figures, or characters, symbols or combinations thereof, etc.) may be disposed at the first surface 201 adjacent to the second connection portions 207a, 207b, to facilitate an user to be able to know the distance in a current setting of the plug-receiving apertures according to the position indication labels when the first connection portion 206a of the first casing 20a buckle to a respective set of protrusions of the plurality of sets of protrusions of the second casing 20b.

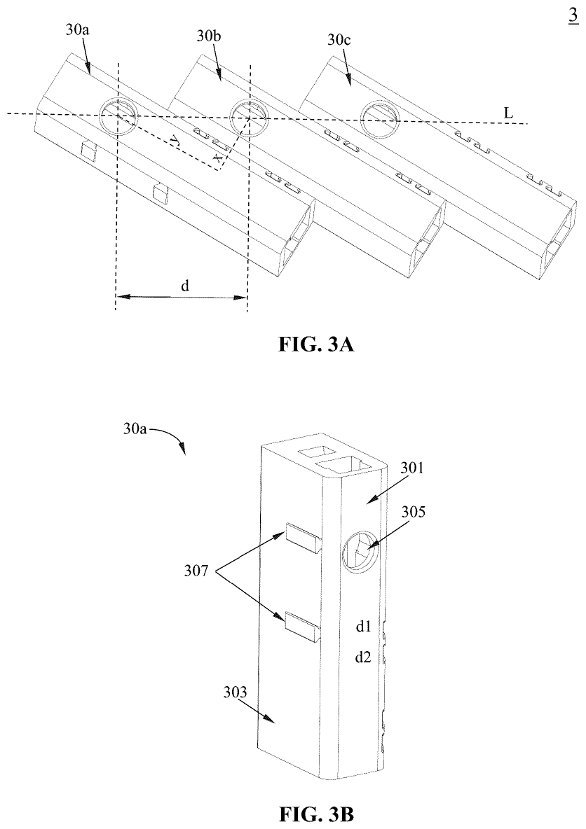

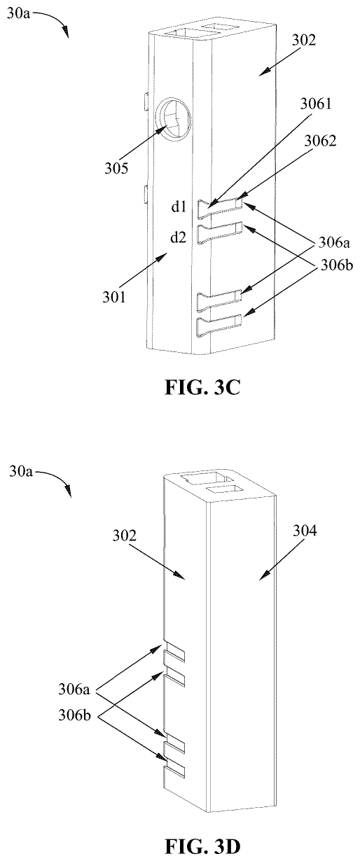

With reference to FIG. 3A, an example cluster block housing 3 for electrical leads according to a third embodiment of the disclosure is illustrated. As shown in FIG. 3A, the cluster block housing 3 includes a plurality of casings 30a, 30b and 30c that have the same shape and are separable or detachable (three casings are shown in the figure, which is only for illustration and is not intended to limit the scope of protection of the present disclosure). FIGS. 3B-3D illustrate a single casing 30a of the cluster block housing 3 of FIG. 3A as viewed from different angles.

As shown in FIGS. 3A-3D, each casing of the plurality of casings 30a, 30b and 30c includes a plug-receiving aperture 305, wherein every adjacently connected two casings (e.g., a first casing 30a and a second casing 30b) can be positioned adjacently at a plurality of positions relative to each other, to change the distance between the plug-receiving apertures of the two casings, and can keep the plug-receiving apertures 305 of the plurality of casings in a row or adjacently staggered.

As shown in FIG. 3A, when the plurality of casings 30a, 30b and 30c are connected together one after another, the plug-receiving apertures 305 of each casing can be kept in one row, i.e., located on a straight line L, to be adapted for straight-line wiring terminals. The distance d between the plug-receiving apertures 305 of two adjacent casings can be calculated by the lateral distance x and longitudinal distance y between the plug-receiving apertures 105 of the two casings, e.g., d=\sqrt{x²+y²}. The lateral distance x between the plug-receiving apertures 305 of the two casings generally remains constant and the longitudinal distance y is variable. In other examples, the plug-receiving apertures 305 of the plurality of casings 30a, 30b and 30c can be kept adjacently staggered. For example, the plug-receiving apertures 305 of the first casing 30a and the second casing 30b are longitudinally offset by a distance y1, the plug-receiving apertures 305 of the second casing 30b and the third casing 30c are longitudinally offset by a distance y2, and the plug-receiving apertures 305 of the first casing 30a and the third casing 30c are longitudinally offset by a distance y3, so that the plug-receiving apertures 305 of the plurality of casings 30a, 30b and 30c are not kept in a straight line (e.g., y1≠y2, or y1=y2 and y3=0, etc.), such as being arranged in a triangle or delta shape (not shown), to be adapted for round type wiring terminals. Since the two casings can be positioned adjacently relative to each other at multiple positions (i.e., offset by different distances), the distance d can be varied to accommodate wiring terminals with different pin spacings. For example, a first position may correspond to a plug-receiving aperture spacing d1, a second position may correspond to a plug-receiving aperture spacing d2, and so on. Without loss of generality, two adjacently connected casings are illustrated below by taking the casings 30a and 30b as examples.

As shown in FIGS. 3A-3D, each casing includes a first connection portion 307 and second connection portions 306a, 306b. The second connection portions 306a, 306b of a first casing 30a of the two casings 30a, 30b can cooperate with the first connection portion 307 of a second casing 30b, so that the first casing 30a can, relative to the second casing 30b, be adjacently positioned against the second casing 30b at the plurality of positions. For example, the second connection portions 306a, 306b include a plurality of sets of connection members, and the first connection portion 307a of the second casing 30b can cooperate with a respective set of connection members of the plurality of sets of connection members of the first casing 30a, so that the first casing 30a can, relative to the second casing 30b, be adjacently positioned against the second casing 30b at a respective position of the plurality of positions.

Each casing includes a top surface or a first surface 301, two opposite side surfaces 302, 303 or a second surface 302 and a third surface 303, wherein the second surface 302 and the third surface 303 are disposed at an angle (e.g., perpendicular, or not perpendicular) relative to the first surface 301. The plug-receiving aperture 305 is disposed at the first surface 301. For example, the second surface 302 may be parallel to the third surface 303. The second connection portions 306a, 306b of the first casing 30a can cooperate with the first connection portion 307 of the second casing 30b, so that the second surface 302 of the first casing 30a abuts against the third surface 303 of the second casing 30b.

In this embodiment, the second connection portions 307a, 307b of the first casing 30a can perform plug fit with the first connection portion 307 of the second casing 30b, so that the second surface 302 of the first casing 30a abuts against the third surface 303 of the second casing 30b. In particular, the second connection portions 306a, 306b of each casing are disposed at the second surface 302 of each casing and the first connection portion 307 is disposed at the third surface 303 of each casing. The first connection portion 307 includes protruding insertion blocks which are shaped to expand upward gradually at least from a lower part, and the second connection portions 306a, 306b include a plurality of sets of grooves which are shaped to at least partially match the insertion blocks. The insertion blocks of the second casing 30b are adapted to be received in a respective set of grooves of the plurality of sets of grooves of the first casing 30a, so that the second surface 302 of the first casing 30a abuts against the third surface 303 of the second casing 30b at a respective position of the plurality of positions. For example, in the case that the first connection portion 307 of the second casing 30b is positioned in a first set of grooves 306a of the first casing 30a, the spacing distance d between the plug-receiving apertures is a first spacing distance d1, while in the case that the first connection portion 307 of the second casing 30b is positioned in a second set of grooves 306b of the first casing 30a, the spacing distance d between the plug-receiving apertures is a second spacing distance d2, where d1<d2. It should be understood that the number of insertion block(s) 307 may be one or more (two insertion blocks are shown in the figure, which is only for illustration and is not intended to limit the scope of protection of the present disclosure). Compared with one insertion block, multiple insertion blocks can provide better positioning effect. In addition, the set number of the plurality sets of grooves may be two or more (two sets are shown in the figure, which is only for illustration and is not intended to limit the scope of protection of the present disclosure) to achieve adjustment of two or more spacing distances between the plug-receiving apertures.

For example, each casing may further include a bottom surface or a fourth surface 304 opposite to the first surface 301, and the insertion blocks extend between the first surface 301 and the fourth surface 304. For example, the insertion blocks may extend laterally between the first surface 301 and the fourth surface 304 in a direction perpendicular to the direction of the length of each casing. The insertion blocks may extend from adjacent the first surface 301 toward the fourth surface 304, extend from adjacent the fourth surface 304 toward the first surface 301, or otherwise extend laterally between the first surface 301 and the fourth surface 304.

As shown in FIG. 3C, each groove of the plurality sets of grooves may be a blind hole to constraint the movement of the insertion block in the groove. The opening portion 3061 of each groove can be larger than the tail portion 3062 to provide reliable fastening force, so that the insert block is tightly received in the groove, thereby securely connecting the two casings together.

In the embodiment of FIGS. 3A-3D, each casing may further include position indication labels associated with the distance between the plug-receiving apertures to indicate multiple positions. For example, the position indication labels may be disposed at the first surface 301. As shown in FIGS. 3B and 3C, the position indication labels (such as characters d1, d2 as indicated in the figures, or characters, symbols or combinations thereof, etc.) may be disposed at the first surface 301 adjacent to the second connection portions 306a, 306b, to facilitate an user to be able to know the distance in a current setting of the plug-receiving apertures according to the position indication labels when the first connection portion 307a of the second casing 30b is inserted into a respective set of grooves of the plurality of sets of grooves of the first casing 30a.

It should be understood that, in addition to the above embodiments, the position indication labels may be provided at other surface(s) of the casing adjacent to the second connection portion, as long as the position indication labels can be observed by the user.

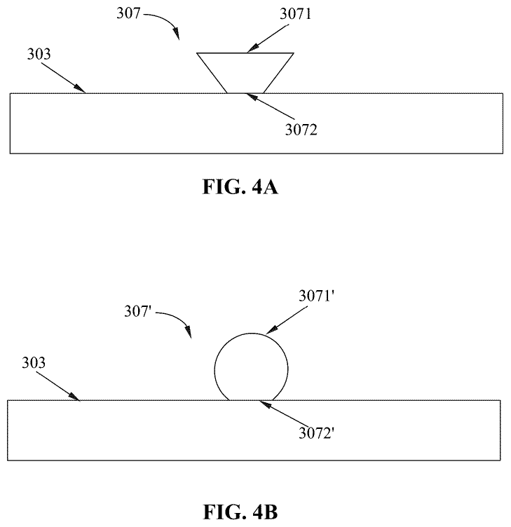

FIG. 4A illustrates a cross-sectional view of a first connection portion 307 of the single casing of FIG. 3B. As shown in FIGS. 3A-3D and 4A, the first connection portion 307 is in the form of a dovetail pin, which is shaped to expand upward (e.g., toward an upper part 3071) gradually at least from a lower part 3072. Also, the second connection portions 306a, 306b are in the form of dovetail grooves to at least partially match the dovetail pin, so that the two casings 30a and 30b are connected together when the first connection portion 307 of the second casing 30b is received in the second connection portions 306a or 306b of the first casing 30a.

FIG. 4B illustrates a cross-sectional view of a first connection portion 307′ of a single casing according to another embodiment of the disclosure. The first connection portion 307 is in the form of a water-drop shape, which is shaped to expand upward (e.g., toward an upper part 3071′) gradually at least from a lower part 3072′. Also, the shape of the second connection portions may at least partially match the water-drop shape, so that the two casings 30a and 30b are connected together when the first connection portion 307′ of the second casing 30b is received in the second connection portions of the first casing 30a.

It should be understood that the first connection portion and the second connection portions that are plug-fitted can adopt various shapes of insertion blocks and grooves known in the art, as long as the two casings 30a and 30b are connected together when the insertion blocks are received in the grooves.

The cluster block housing for electrical leads as described in the above embodiments provides advantages over the terminal housings in the prior art. Multiple casings can be flexibly assembled into a housing on demand to be adapted for wiring terminals with different numbers of pins. The distance between the plug-receiving apertures of adjacent casings can be adjusted at multiple positions, which allows easy integration of commonly used pin spacings. The cluster block housing has a modularized structure and there is no need to remake a mold to design the housing for different wiring terminals, thus having low development cost. Hence, the cluster block housing can be quickly applied to various electrical leads, which saves cost.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cluster block housing for electrical leads, comprising:
a plurality of separable, connected casings, each casing of the plurality of casings including a plug-receiving aperture, adjacently connected two casings of the plurality of casings are adapted to be positioned adjacently at a plurality of positions relative to each other, each of plurality of positions corresponds to a distinct distance between the plug-receiving apertures of the two adjacent casings, the plug-receiving apertures are maintained in a row in each of the plurality of positions.

2. The cluster block housing according to claim 1, wherein:
each casing includes a first connection portion and a second connection portion; and
the first connection portion of a first casing of the two casings cooperates with the second connection portion of a second casing of the two casings such that the first casing can be adjacently positioned against the second casing at the plurality of positions.

3. The cluster block housing according to claim 2, wherein:
each casing includes a first surface, and a second surface and a third surface that are opposite, the second surface and the third surface are disposed at an angle relative to the first surface, and the plug-receiving aperture is disposed at the first surface; and
the first connection portion of the first casing cooperates with the second connection portion of the second casing, such that the second surface of the first casing abuts against the third surface of the second casing.

4. The cluster block housing according to claim 2, wherein the first connection portion of the first casing forms at least one of one of snap fit, buckle fit, or plug fit with the second connection portion of the second casing.

5. The cluster block housing according to claim 3, wherein the second surface of the first casing abuts against the third surface of the second casing with the first and second casings connected.

6. The cluster block housing according to claim 5, wherein the first connection portion and the second connection portion of the each casing are disposed at the first surface of the each housing, and the first connection portion includes a snap member and the second connection portion includes a snap groove.

7. The cluster block housing according to claim 6, wherein the snap member of the first casing are adapted to be positioned at different locations in the snap groove of the second casing such that the second surface of the first casing abuts against the third surface of the second casing at a respective position of the plurality of positions.

8. The cluster block housing according to claim 7, wherein the each casing further includes positioning members disposed at the second surface and a plurality of sets of positioning holes disposed at the third surface.

9. The cluster block housing according to claim 8, wherein the positioning members of the first casing are adapted to be positioned in a respective set of positioning holes of the plurality of sets of positioning holes, such that the second surface of the first casing abuts against the third surface of the second casing at a respective position of the plurality of positions.

10. The cluster block housing according to claim 5, wherein the first connection portion and the second connection portion of the each casing are disposed at the first surface of the each housing, and the first connection portion includes buckle members having openings and the second connection portion includes a plurality of sets of protrusions.

11. The cluster block housing according to claim 10, wherein a respective set of protrusions of the plurality of sets of protrusions of the second casing is adapted to be positioned in the openings of the buckle members of the first casing, such that the second surface of the first casing abuts against the third surface of the second casing at a respective position of the plurality of positions.

12. The cluster block housing according to claim 5, wherein:
the each casing further includes a fourth surface opposite to the first surface, and a third connection portion and a fourth connection portion are provided at the fourth surface; and
the third connection portion of the first casing forms a snap fit or buckle fit with the fourth connection portion of the second casing, such that the second surface of the first casing abuts against the third surface of the second casing.

13. The cluster block housing according to claim 5, wherein:
the first connection portion of the each casing is disposed at the third surface of the each casing and the second connection portion is disposed at the second surface of the each casing, the first connection portion includes protruding insertion blocks which are shaped to expand upward gradually at least from a lower part, and the second connection portion includes a plurality of sets of grooves which are shaped to at least partially match the insertion blocks; and
the insertion blocks of the second casing are adapted to be received in a respective set of grooves of the plurality of sets of grooves of the first casing, such that the second surface of the first casing abuts against the third surface of the second casing at a respective position of the plurality of positions.

14. The cluster block housing according to claim 13, wherein the each casing further includes a fourth surface opposite to the first surface, and the insertion blocks extend between the first surface and the fourth surface.

15. The cluster block housing according to claim 13, wherein each groove of the plurality of sets of grooves is a blind hole.

16. The cluster block housing according to claim 13, wherein each groove of the plurality of sets of grooves defines an opening larger at a front receiving end thereof than a real thereof.

17. The cluster block housing according to claim 2, wherein the each casing further includes position indication labels associated with the distance between the plug-receiving apertures.

18. The cluster block housing according to claim 17, wherein the position indication labels are disposed at a surface of the each casing.

19. The cluster block housing according to claim 18, wherein the position indication labels are disposed adjacent to the second connection portion at the surface.

20. A cluster block housing for electrical leads, comprising:
a first casing having a first plug-receiving aperture;
a second casing having a second plug-receiving aperture, the first casing connectable to the second casing in a plurality of discrete positions, in each of plurality of discrete positions the first and second plug-receiving apertures are arranged in a row and each of the plurality of discrete positions corresponds to a distinct distance between the first and second plug-receiving apertures.
